(19) United States
(12) Patent Application Publication
(10) Pub. No.: US 2024/0143379 A1
(43) Pub. Date: May 2, 2024

(54) APPARATUS AND METHOD FOR ENABLING SEQUENTIAL PREFETCHING INSIDE A HOST

(71) Applicant: Intel Corporation, Santa Clara, CA (US)

(72) Inventors: Chandra PRAKASH, Bangalore (IN); Aravinda PRASAD, Bangalore (IN); Sreenivas SUBRAMONEY, Bangalore (IN)

(21) Appl. No.: 18/466,551

(22) Filed: Sep. 13, 2023

(51) Int. Cl. G06F 9/455

(52) U.S. Cl. CPC G06F 9/45558; G06F 9/45545; G06F 2009/45583

(57) ABSTRACT

It is provided an apparatus for enabling sequential prefetching inside a host, the apparatus comprising interface circuitry, machine-readable instructions, and processing circuitry to execute the machine-readable instructions. The machine-readable instructions comprise instructions to identify a first memory access pattern of an application in a guest virtual address space inside a virtual machine. The application is running inside the virtual machine and wherein the virtual machine is running on the host. The machine-readable instructions further comprise instructions to modify a layout of a guest physical address space, wherein the guest physical address space is corresponding to the guest virtual address space, to sequentialize a second memory access pattern in a host virtual address space. The second memory access pattern in the host virtual address space is corresponding to the first memory access pattern of the application in the guest virtual address space.

### BACKGROUND

Virtual machines (VMs) are an important part of cloud computing because they provide a way to efficiently leverage the capabilities of physical hardware while providing isolated and customizable computing environments for users. In this setup, the memory of the physical hardware becomes an important resource. Each VM is allocated a portion of the server's memory to ensure that it operates effectively without interfering with other VMs. Memory allocation directly affects the performance and capacity of both individual VMs and the overall cloud infrastructure. Memory management is important to maximizing the potential of VMs and balancing performance requirements with physical hardware constraints.

### BRIEF DESCRIPTION OF THE FIGURES

Some examples of apparatuses and/or methods will be described in the following by way of example only, and with reference to the accompanying figures, in which:

FIG. 1a illustrates an example of block diagram of an apparatus or device communicatively coupled to a host;

FIG. 1b illustrates an example of a block diagram of a host comprising an apparatus or a device;

FIG. 2 schematically illustrates aspects of modifying a layout of the guest physical address, GPA, space of a sequential memory access pattern;

FIG. 3 schematically illustrates aspects of modifying a layout of the GPA space of a non-sequential memory access pattern;

FIG. 4 schematically illustrates an adjusting of a mapping between the host virtual address, HVA, space and the HPA, host physical address, space when modifying the GPA space; and

FIG. 5 illustrates an example of a method for enabling sequential prefetching inside a host.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

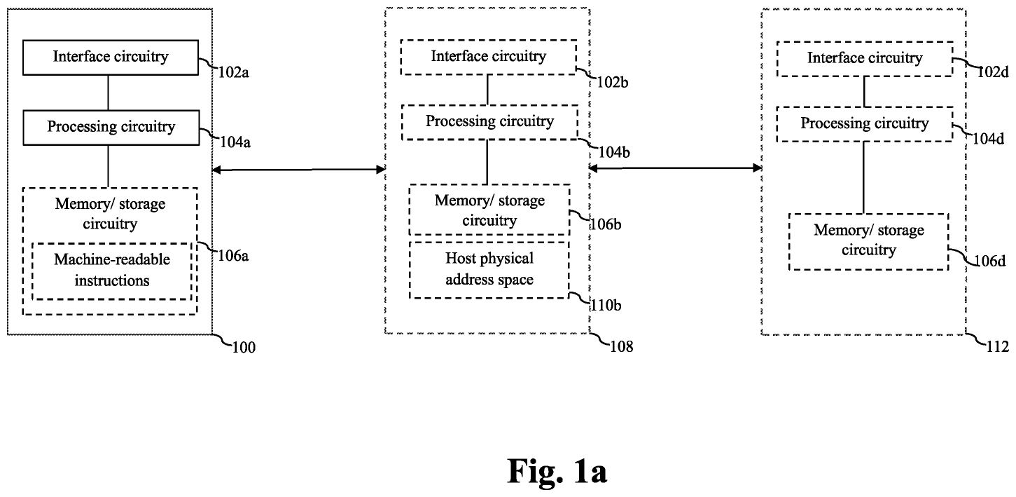

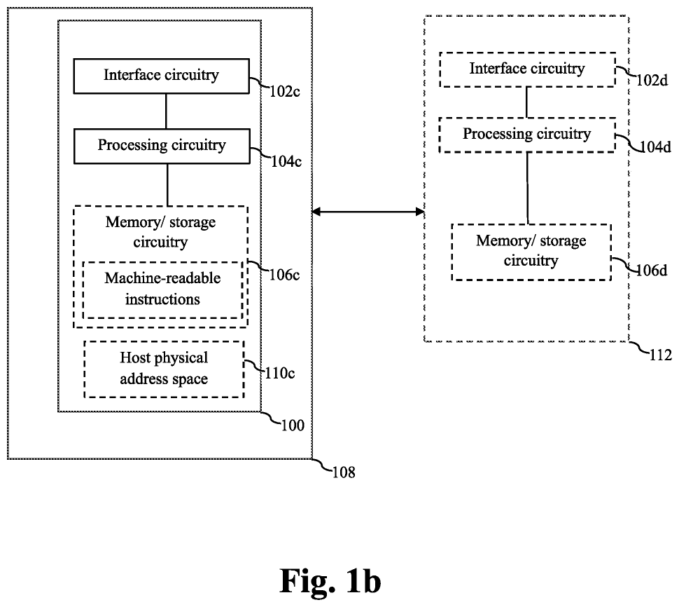

FIG. 1a shows a block diagram of an example of an apparatus 100 or device 100 communicatively coupled to a host 108. FIG. 1b shows a block diagram of an example of a host 108 comprising an apparatus 100 or a device 100.

The apparatus 100 comprises circuitry that is configured to provide the functionality of the apparatus 100. For example, the apparatus 100 of FIGS. 1a and 1b comprises interface circuitry 102a/102c, processing circuitry 104a/104c and (optional) memory/storage circuitry 106a/106c. For example, the processing circuitry 104a/104c may be coupled with the interface circuitry 102a/102c and with the storage circuitry 106a/106c. The host 100 may be optionally communicatively coupled to a client 112.

In FIG. 1a the host 108 may comprise interface circuitry 102b, processing circuitry 104b and (optional) memory/storage circuitry 106b. The storage circuitry 106b may comprise a host physical address space 110b. For example, the processing circuitry 104b may be coupled with the interface circuitry 102b and with the storage circuitry 106b.

In FIG. 1b the host 108 may comprise interface circuitry 102b, processing circuitry 104b and (optional) memory/storage circuitry 106b. The host 108 may comprise a host physical address space 110b which may be comprised in the storage circuitry 106b.

A client 112 may comprise interface circuitry 102d, processing circuitry 104d and (optional) memory/storage circuitry 106d. For example, the processing circuitry 104d may be coupled with the interface circuitry 102d and with the storage circuitry 106d.

The host 108 may be a physical computer on which a virtualization software (or hypervisor) is running which allows to create and run one or more separate virtual machines, VMs, on the host computer 108.

A virtual machine may emulate a complete hardware system—for example from a processor to a network card—in a self-contained, isolated software environment, enabling it to run its own operating system (for example referred to as the guest operating system) and applications just as if they were running on a physical system. For example, the host computer may provide the physical resources that are shared among one or more virtual machines running on it. The hypervisor is responsible for managing these resources and ensuring each virtual machine has access to what it needs, without interfering with the others. A host, for example the host 108, that on which the VM(s) is/are running may be the actual hardware, the physical computer (also referred to as bare metal system) and may provide the physical resources, such as CPU, memory, and storage, for example a processing circuitry 104, interface circuitry 102 and/or memory circuitry 106, that are used by the VMs.

The host 108 may be a desktop computer, a laptop, or a workstation (e.g., that may be high-performance computers). The host 108 may be physical server or a virtual server running on a physical server. A server may be a computer or system designed to manage and distribute network resources. This includes both physical servers and virtual servers. A physical server is a standalone machine that is dedicated to running server-based applications. Physical servers run server-grade operating systems and may be designed to be highly reliable and robust, operating continuously to serve client requests. A virtual server may be a server that shares hardware and software resources with other operating systems and is hosted on a physical server. Through virtualization technology, a physical server can be partitioned into multiple independent “virtual” servers, each with its own operating system and set of applications. Each virtual server behaves as if it is a separate physical server, providing a layer of abstraction that allows for easy scalability and system management. Whether physical or virtual, a server's primary function is to provide data, resources, and services to other computers (clients) over a network. Server-based applications, of a virtual or a physical server, may be applications of web servers, database servers, email servers, file servers, game servers, application servers, cloud servers and/or enterprise servers.

Furthermore, the host 108 may be a server, for example a cloud-based server, wherein a server may host many virtual machines simultaneously. Further, the host 108 may be a system of hosts, which occurs to the outside, for example the VM(s) as a single host. To such a system of hosts it is also referred to as host 108. A host-system may be a for example a cloud-based system, that is a server or group of servers in a data center for example owned by a cloud service provider. Customers may rent virtual machines from the provider, which run on these hosts.

A host 108 may be communicatively coupled to a client 112. A client 112, may be physical computer (hardware) or a software that accesses a service made available by a server, for example the host 108. The client 112 may send a request to a server, and the server fulfills the request and sends back the data or service results to the client. The client 112 may be a desktop computer, a laptop, a smartphone, or other internet-connected devices. Further, the client 112 may be web browser, or an email client. Further the client 114 may access a cloud-based server system.

For example, the processing circuitry 104a/104c may be configured to provide the functionality of the apparatus 100, in conjunction with the interface circuitry 102a/102c (for exchanging information, e.g., with other components inside or outside apparatus 100) and the storage circuitry 106a/106c (for storing information, such as machine-readable instructions).

For example, the processing circuitry 104b may be configured to provide the functionality of the host 108, in conjunction with the interface circuitry 102b (for exchanging information, e.g., with other components inside or outside the host 108) and the storage circuitry 106b (for storing information, such as machine-readable instructions).

For example, the processing circuitry 104d may be configured to provide the functionality of the host client 112, in conjunction with the interface circuitry 102d (for exchanging information, e.g., with other components inside or outside the host client 112) and the storage circuitry 106d (for storing information, such as machine-readable instructions).

Likewise, the device 100 may comprise means that is/are configured to provide the functionality of the device 100.

The components of the device 100 are defined as component means, which may correspond to, or implemented by, the respective structural components of the apparatus 100. For example, the device 100 of FIGS. 1a and 1b comprises means for processing 104a/104c, which may correspond to or be implemented by the processing circuitry 104a/104c, means for communicating 102a/102c, which may correspond to or be implemented by the interface circuitry 102a/102c, and (optional) means for storing information 106a/106c, which may correspond to or be implemented by the storage circuitry 106a/106c. In the following, the functionality of the device 100 is illustrated with respect to the apparatus 100. Features described in connection with the apparatus 100 may thus likewise be applied to the corresponding device 100.

In general, the functionality of the processing circuitry 104a/104b/104c/104d or means for processing 104a/104b/104c/104d may be implemented by the processing circuitry 104a/104b/104c/104d or means for processing 104a/104b/104c/104d executing machine-readable instructions. Accordingly, any feature ascribed to the processing circuitry 104a/104b/104c/104d or means for processing 104a/104b/104c/104d may be defined by one or more instructions of a plurality of machine-readable instructions. The apparatus 100 or device 100 may comprise the machine-readable instructions, e.g., within the storage circuitry 106a/106b/106c/106d or means for storing information 106a/106b/106c/106d.

For example, the storage circuitry 106a/106b/106c/106d or means for storing information 106a/106b/106c/106d may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The host physical address space 110b/110c of the host 108 may refer to the entire range of memory addresses (e.g., the memory circuitry 106 or other elements storing data of the host 108) and its controlling. The host physical address space 110b/110c may comprise circuitry that controls the locating and accessing of every byte of memory in the host 108. Each unique address corresponds to a different location in the physical memory. For example, the host physical address space 110b/110c may be implemented by the processing circuitry 104b/104c controlling memory of the memory circuitry 106b/106c in the host 108.

The interface circuitry 102a/102b/102c/102d or means for communicating 102a/102b/102c/102d may correspond to one or more inputs and/or outputs for receiving and/or transmitting information, which may be in digital (bit) values according to a specified code, within a module, between modules or between modules of different entities. For example, the interface circuitry 102a/102b/102c/102d or means for communicating 102a/102b/102c/102d may comprise circuitry configured to receive and/or transmit information.

For example, the processing circuitry 104a/104b/104c/104d or means for processing 104a/104b/104c/104d may be implemented using one or more processing units, one or more processing devices, any means for processing, such as a processor, a computer or a programmable hardware component being operable with accordingly adapted software. In other words, the described function of the processing circuitry 104a/104b/104c/104d or means for processing 104a/104b/104c/104d may as well be implemented in software, which is then executed on one or more programmable hardware components. Such hardware components may comprise a general-purpose processor, a Digital Signal Processor (DSP), a micro-controller, etc.

If it is not referred to a specific circuitry a/b/c/d, all or some of the a/b/c/d circuitry is/are implied.

The processing circuitry 104a/104c is configured to identify a first memory access pattern of an application in a guest virtual address space inside a virtual machine, wherein the application is running inside the virtual machine and wherein the virtual machine is running on the host 108. The processing circuitry 104a/104c is configured to modify a layout of a guest physical address space, wherein the guest physical address space is corresponding to the guest virtual address space, to sequentialize a second memory access pattern in a host virtual address space. The second memory access pattern in a host virtual address space is corresponding to the first memory access pattern of the application in the guest virtual address space.

Prefetching may be a technique used in computer architecture to improve the speed and efficiency of memory access. It may involve proactively loading data from a slower memory (for example RAM), for example (a part of) the memory circuitry 106, to the faster memory (for example cache, for example part of the processing circuity 102) before it is needed by the processing circuitry 104. The goal of prefetching is to prevent the processing circuitry 104 from having to wait for data to be fetched from the main memory, which can be a slow operation and can significantly impact system performance. Prefetching may be based on the principle of locality, which may suggest that data located spatially close together in the memory may be accessed close together in time. This principle may allow a prefetcher to predict what data will be needed next and load that data into cache ahead of time. Sequential prefetching in this regard, may be based on the observation that many applications (for example computer programs) access the memory circuitry in a predictable, sequential memory access pattern. A prefetcher may monitor a processor's memory accesses to detect a memory access pattern, and if the processor is accessing memory locations in sequence (for example, sequence of addresses 10, 11, 12, etc.), it may assume the processor will continue this sequential pattern. The prefetcher may then start loading data from the next sequential addresses into the cache. So, if the processor is currently accessing for example an address 12, the prefetcher might load data from addresses 13, 14, 15, etc., into the cache. Therefore, if an application is accessing memory addresses in sequence (sequentially) there is a high likelihood that it will continue to do so. When the processor needs the data from these addresses, it may quickly retrieve it from the cache instead of having to wait for it to be fetched from main memory. However, in the context of virtual machines, VMs, and with non-sequential memory access patterns of applications, sequential prefetching may not be possible. Therefore, there may be a need to enable sequential perfecting in a host 108.

A memory access pattern may be a specific sequence (or pattern) and/or a specific manner in which an application (for example a program) accesses a memory location in a memory space during its execution. This may refer to a virtual memory space or a physical memory space and also refer to virtual/physical memory spaces of either a VM or a host, as also described below.

A memory access pattern of the application may be a sequential access pattern, or a deterministic non-sequential access pattern or a stride access pattern.

For example, in a sequential access pattern, an application accesses memory locations in a consecutive (sequential) order. The application may read or write data elements in a linear sequence, typically following the order of their storage or iteration through an array or a data structure, as address, address+1, address+2, . . .

Another example of a memory access pattern may be a non-sequential but deterministic access pattern. In a non-sequential but deterministic pattern, the access locations may not be in sequential order, but their order is deterministic and predictable. In other words, the program may consistently follow a specific pattern, but the accessed memory locations may not be consecutive.

Another example of a memory access pattern may be a random and non-deterministic access pattern, where an application may access memory locations in a non-sequential and unpredictable order. It may jump around to different memory locations based on specific conditions, data dependencies, or dynamic calculations.

Yet another example of a memory access pattern may be a stride access pattern, where an application may access a memory location at regular intervals. The application may access elements with a fixed stride or step size, skipping a certain number of elements between each access. Stride access patterns can occur in algorithms like matrix operations or when iterating over multidimensional arrays.

An application may refer to a software program that is executable and performing tasks or providing services on a computer system. An application may be a complex software code with many functions like a word processing software or it may comprise a single task, for example like accessing an array or performing an arithmetic operation.

A layout of a memory space or address space may describe the order of the memory pages of that address space. To modify a layout of an address space may comprise arranging the memory pages of that address space in another order than it was before. To modify a layout of a guest physical address space, may also be referred to as performing a re-layout of a guest physical address space and vice versa.

To sequentialize a second memory access pattern in a host virtual address space, by modifying a layout of a guest physical address space may comprise to modify the mapping from the guest virtual address space to the guest physical address space (and updating a corresponding page table) in such a way that the sequential or non-sequential memory access pattern in guest virtual address space has a corresponding sequential memory access pattern in the host virtual address space, due to the modified mapping.

For example, virtual machines are used in the context of cloud computing and cloud service providers (CSPs) may want to pack as many VMs as possible on a single physical machine (for example a server) to maximize system utilization. However, the number of VMs (also referred to as VM instances) that may be run on a system is limited by the total memory capacity of the system. However, increasing the memory capacity of CSP's data center servers may be very expensive because memory costs may account for a large amount (for example 49%) of the Total Cost of Ownership (TCO) of a datacenter. Compared to that, CPU may account for a much lower TCO (for example 17%). One way to address the issue of ever-increasing memory inefficiencies in cloud environments may be to place a memory page (that is fixed-sized block of a memory space) of VMs that has not been accessed or used for a significant amount of time (that may be referred to as “cold memory page”) in a compressed memory pool (for example ZSWAP or Slab in Linux OS). This can enhance memory capacity and enable a CSP to deploy a greater number of VMs per gigabyte of physical memory. However, memory pages may be decompressed (incurring a penalty) whenever an application accesses them. Decompressing a VM's page on-demand (e.g., when an application faults on a memory page that was placed in compressed memory pool) may incur high overheads. For example, performance of the application(s) running inside the VM depends on how fast the page is decompressed whenever the application accesses a page in the compressed pool. To eliminate high decompression overheads from critical page fault path, sequential pre-fetching of pages from compressed memory pool may be employed. For example, prefetching may comprise loading and/ or decompressing a cold memory page that was compressed and stored in a compressed memory pool. In sequential prefetching, a set of n sequential pages from a faulting virtual address may (speculatively) be prefetched or decompressed from a compressed memory pool, such that a predicted future accesses to these sequential pages will not incur additional page faults. For example, if an application faults on page X that is placed in compressed memory pool, pages X+1, X+2, . . . , X+n are prefetched (e.g., decompressed) from the compressed pool and placed in the memory (for example DRAM).

Further, in computer technology the concept of a virtual address space is used. This may be a concept that is independent of the usage of a virtual machine and should not be confused because of the term “virtual”. A virtual address is a memory address that may be generated or used by a running program (process) during its execution. The program may use these addresses to read and write data. However, these memory addresses may not correspond directly to actual physical locations in memory. Instead, they're mapped to physical addresses by a Memory Management Unit (MMU) in hardware, with help from the operating system. When a program for example wants to access a memory location, it may do so using a virtual address. This address is then translated into a physical address by the MMU. The MMU may use a data structure called a page table, maintained by the operating system, to perform this translation. The process of translating a virtual address to a physical address may be called “address translation” or “page mapping” or “mapping”. This system of virtual addressing may enable each program to behave as if it has exclusive use of the memory, may enhance the security and stability of the system, and may allow the operating system to make more efficient use of the physical memory. A set of virtual addresses may be referred to as virtual address space. Prefetching may be performed on the virtual address level, that is the memory access pattern as they are seen in the virtual address space may be relevant for prefetching.

The concept of virtual addresses may also be used in the context of VMs. In this regard guest virtual addresses, GVAs, within a guest virtual address space may be the set of virtual memory addresses an application (e.g., a program) running inside a VM (which runs on the host 108) perceives as its own. To the guest operation system, OS, and its applications, these addresses look like the actual memory they're working with, but they are virtual addresses from the perspective of the host 108. Guest physical addresses, GPA, within a guest physical address space may be the addresses that after a guest OS's MMU may translate its GVAs, may be perceived by the guest OS as physical addresses. These are still not the actual physical addresses, because the VM doesn't have direct access to the host's physical memory. Host virtual addresses, HVAs, within a host virtual address space may be a set of virtual memory addresses that applications running on the host 108 may use. These are virtual addresses generated and/or used by the host's processing circuitry 104 and OS. Host physical addresses, HPAs, within a host virtual address space 110b/c may be the actual physical addresses in the memory hardware, for example the storage circuity 106b/c of the host 108. The host's MMU, which may be comprised in the host virtual address space 110b/c may translate the HVAs into HPAs for actual data storage and retrieval.

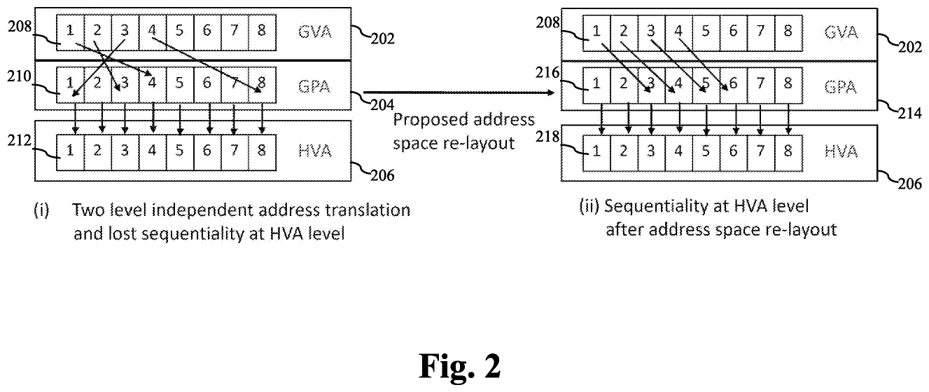

Therefore, as also can be seen in FIGS. 2, 3 and 4, when an application which is running in a VM which is running on the host 108, the memory references of an application running on the VM may go through three levels of address translation: First GVA to GPA, second from the GPA to the HVA and third from the HVA to the HPA.

As described above a memory access pattern may be a specific pattern in which an application accesses a memory location in a memory space during its execution. There may be a memory access pattern in the guest virtual address space of an application that is running inside a VM. This memory access pattern may be a first memory access pattern. There may be a memory access pattern in the GPA space which may be the memory access pattern which may be the translation of the memory access pattern of the application in the GVA space to the GPA space. This memory access pattern may be a third memory access pattern. There may be a memory access pattern in the HVA space which may be the memory access pattern which may be the translation of the memory access pattern of the application in the GVA space to the GPA space to the HVA space. This memory access pattern may be a second memory access pattern. There may be a memory access pattern in the HPA space which may be the memory access pattern which may be the translation of the memory access pattern of the application in the GVA space, to the GPA space to the HVA space to the HPA space. This memory access pattern may be a fourth memory access pattern.

However, since prefetching may be performed on the virtual address level, and in a virtual machine environment prefetching may done at the host level (host-managed), prefetching may be done at the HVA level for applications running at the GVA level. With regards to prefetching two address translations, from GVA to GPA and from GPA to HVA are most relevant.

Therefore, sequential prefetching for an application (for example for workloads) with a sequential memory access pattern (for example of pages from a compressed pool such as ZSWAP or the like) may only work when the application is running on a bare metal system (meaning no VM). However, when the same application is running inside a VM, which is running on the host 108, sequential prefetching (for example of pages from a host-managed compressed pool) may not work due to the two levels of address translations, which destroyed a sequential memory access pattern in the GVA space by translating it to the HVA space. The problem of two-level address translation occurs for example in a virtualized setup. For example, virtual address to physical address (one level) translation is required in a non-virtualized setup (also referred to as “bare metal”) to access the data (hardware address). An additional address translation inside the VM e.g., GVA to GPA, may be required if the application is run in VM running on a host 108. For example, in a kernel-based virtual machine (KVM) which may be independent of the address translation inside the host. In a Quick Emulator (QEMU)/KVM based virtualized setup, GPAs may be mapped linearly (one-to-one) to HVA. GVA to GPA mapping may be managed by the guest operating system (OS) kernel. Therefore, at the host context (e.g., HVA point of view), an original sequential memory access pattern of an application running inside a guest (GVA) is lost due the above described two-level independent address translation. Therefore, sequential prefetching (for example of pages from host-managed compressed memory pool) may not be effective for sequential application running inside a virtualized environment because the page accesses may not be sequential in the host context due to two levels of address translation.

Another problem may be, that an application does not even exhibit a sequential access pattern in the GVA space and hence cannot benefit from sequential prefetching. Such applications may not exploit sequential prefetching inside the host 108 for example from the compressed memory pool due to inherent lack of spatial locality. For example, sequential prefetching accuracy may drop by 32% to 47% for sequential applications when they are run inside a virtual machine. Therefore, sequential prefetching may be re-enabled in these cases.

The apparatus 100 (for example the processing circuitry 104a/104c) identifies a first memory access pattern of an application in a guest virtual address space inside a virtual machine. The application is running inside the VM, and the virtual machine is running on the host 108.

The first memory access pattern may be a sequential memory access pattern, a non-sequential but deterministic memory access pattern or a stride memory access pattern.

A first memory access pattern of an application in the GVA space and a third memory access pattern in the GPA space and a second memory access pattern in the HVA space and a fourth memory access pattern in the HPA space may correspond to each other in that regard that the different address spaces are translated to each other. That may mean that each page from an address space is translated by a translation into a memory page of another memory space.

That could mean that there is a translation from the GVA space to the GPA space, a translation from the GPA space to HVA space and a translation from the HVA space to the HPA space. These memory space translations may also be referred to as mappings from one space to the other, where one memory page of a memory space is mapped onto another memory space. That may mean, that each memory page of an application in the GVA space corresponds to a specific memory page in the GPA space and therefore the first memory access pattern in the GVA space corresponds the third memory access pattern in the GPA space. That may mean, that each memory page of the application in the GPA space corresponds to a specific memory page in the HVA space and therefore the third memory access pattern in the GPA space corresponds the second memory access pattern in the HVA space. That may mean, that each memory page of the application in the HVA space corresponds to a specific memory page in the HPA space and therefore the second memory access pattern in the GPA space corresponds the fourth memory access pattern in the HPA space.

Therefore, to identify a first memory access pattern of an application in the GVA space may comprise to identify the translation/mapping from the GVA space to the GPA space and identify the corresponding third memory access pattern in the GPA space. To identify a first memory access pattern of an application in the GVA space may comprise to identify the translation/mapping from the GPA space to the HVA space and identify the corresponding second memory access pattern in the HVA space. To identify a first memory access pattern of an application in the GVA space may comprise to identify the translation/mapping from the HVA space to the HPA space and identify the corresponding fourth memory access pattern in the HPA space.

Then the apparatus 100 (for example the processing circuitry 104a/104c) may modify a layout of a guest physical address space, wherein the guest physical address space is corresponding to the guest virtual address space, to sequentialize a second memory access pattern in a host virtual address space, wherein the second memory access pattern in the host virtual address space is corresponding to the first memory access pattern of the application in the guest virtual address space.

For example, to modify a layout of the GPA space (a re-layout of the GPA space) may comprise a re-layout of the GVA mapping to GPA space that enable or enforce sequential prefetching in the host (HVA space).

A re-layout of an address space (also referred to as to modify an address space) may be a re-ordering of the memory pages. That may mean, that an address space with an old memory page order is re-ordered into an address space with a new order of memory pages. For example, the re-layout of the GPA space may be implemented by updating corresponding entries of a page table. The page table may be a Translation Lookaside Buffer (TLB) or the like. The table may store which GVA is mapped to which GPA. The re-layout of the GPA may be achieved by updating the entries of the page table such that the new GVAs correspond to the new GPAs. For example, an address space may be re-layout (only showing a part of an address space, where other parts may be re-layout as well or not be re-layout), from an ordering like:

. . . , (N−2), (N−1), N, (N+1), (N+2), (N+3), (N+4), (N+5), . . .

to, an ordering like:

. . . , (N+2), N (N+1), (N−1), (N+5), (N+4), (N+3), (N−2), . . .

(The addition/subtraction of integers refers to a shifting a corresponding number of memory pages to the right/left starting from a memory address N).

In this regard a re-layout of an address space may comprise performing a re-layout or a re-shaping of the mapping to and/or from this address space. Also, performing a re-layout or a re-shaping of the mapping to and/or from this address space may comprise a re-layout of an address space. For example, an application in the GVA space may have a memory access pattern, like M_{GVA}, (M+1)_{GVA}, (M+2)_{GVA}, (M+3)_{GVA}. A mapping corresponding to the application, from the GVA space to the GPA space, may map the following memory pages to each other (this may be an example of a part of a page table):

M_{GVA}→(N−1)_{GPA}, (M+1)_{GVA}→(N+1)_{GPA}, (M+2)_{GVA}→(N+5)_{GPA}, (M+3)_{GVA}→(N+3)_{GPA}.

(M+3)_{GVA}→(N+3)_{GPA}

When a re-layout of the GPA space is performed, as described above, then the mapping may automatically also be re-layout (and for example the corresponding page table is updated) as follows:

M_{GVA}→(N)_{GPA}, (M+1)_{GVA}→(N−1)_{GPA}, (M+2)_{GVA}→(N−2)_{GPA}, (M+3)_{GVA}→(N+4)_{GPA}.

(M+3)_{GVA}→(N+4)_{GPA}

The same is true for mappings of any other lengths and any other (non-sequential or stride) order. The same may be true for other mappings between the memory spaces as described above.

The apparatus may perform the re-layout of a guest physical address by sequentializing a third memory access pattern in the guest physical address space, which is corresponding to the first memory access pattern of the application in the guest virtual address.

To sequentialize a second memory access pattern in a host virtual address space, by modifying a layout of a guest physical address space may comprise to re-layout the mapping from the GVA space to the GPA space (and updating the page table) in such a way that the sequential or non-sequential memory access pattern in GVA space has a corresponding sequential memory access pattern in the HVA space.

If the mapping between the GPA and HVA is be linear, that is it may be a one-to-one mapping (for example in the case of a KVM setup), to sequentialize a second memory access pattern in a host virtual address space may comprise: The apparatus 100 (for example the processing circuitry 104a/104c) may identify (for example by a first fit or best fit approach) a sequence of as many contiguous memory pages within the GPA space, as is the length as the first memory access pattern of the application in the GVA space. Then, the apparatus 100 (for example the processing circuitry 104a/104c) may identify the first memory page in the GVA space of the first memory access pattern of the application and the corresponding memory page in the GPA space to which it currently points. Then the apparatus 100 (for example the processing circuitry 104a/104c) may move the content of this identified memory page in the GPA space from its current position in the GPA space to the first memory page of the identified sequence of the contiguous memory pages within the GPA space. This moving may be implemented by changing the corresponding entry in a page table, such that the memory page in the GPA space to which the memory page in the GVA space is mapped is changed as described above. When moving the content of a memory page within the GPA space, the corresponding mapping from the GVA space to that GPA space memory page also moves accordingly. (Therefore, it may be also referred to that process also as: the mapping of the first page of the memory access pattern of the application in the GVA space to the GPA space may be re-layouted to map to first memory page in the GVA space of the first memory access pattern of the application to the first memory page of the identified sequence of the contiguous memory pages within the GPA space). The former content of that GPA memory page (for example a HVA to which it points or the like) may be stored in a buffer or the like for later use, or it may be swapped with the content of the memory page whose content was moved to its position (the changing of the corresponding data in physical memory, e.g., HPA space, is described below). This may be implemented by the page table/list which contains the mappings. This table that may be updated. This process may be repeated for each memory page in the identified contiguous memory pages within the GPA space (that is for each memory page accessed by the application). Then the order of the GPA space was re-layout. Because in this case the mapping between the GPA and HVA is linear (that is it may be a one-to-one mapping, for example in the case of a KVM setup), the second memory access pattern in the HVA space, corresponding to the first memory access pattern of the application, is also re-layout. Because the memory access pattern in the GPA space is sequential now the memory access pattern in the HVA space is now a sequential memory access pattern, too. A sequential memory access pattern refers to a way in which data or instructions are accessed in memory in a linear or consecutive order.

If the mapping between the GPA and HVA may not be linear, to sequentialize a second memory access pattern in a host virtual address space may comprise: The apparatus 100 (for example the processing circuitry 104a/104c) may identify (for example by a first fit or best fit approach) a sequence of as many contiguous memory pages within the HVA space, as is the length as the first memory access pattern of the application in the GVA space. Then, the apparatus 100 (for example the processing circuitry 104a/104c) may begin with the first memory page of this identified sequence in the HVA space and identify the corresponding memory page position in the GPA space which is assigned by the memory mapping/translation between the GPA space and the HVA space to the first memory page of this identified sequence in the HVA space. Then the apparatus 100 (for example the processing circuitry 104a/104c) may identify the first memory page in the GVA space of the first memory access pattern of the application and the corresponding memory page in the GPA space to which it points. Then the apparatus 100 (for example the processing circuitry 104a/104c) may move the content (which may be an address in the host virtual address space) of this identified memory page in the GPA space from its current position in the GPA space to the memory page position in GPA space, which is assigned by the memory mapping between the GPA space and the HVA space to the first memory page of the identified sequence in the HVA space. This moving may be implemented by changing the corresponding entry in a page table, such that the memory page in the GPA space to which the memory page in the GVA space is mapped is changed as described above. When moving the content of a memory page within the GPA space, the corresponding mapping from the GVA space to that GPA space memory page also moves accordingly. (Therefore it may be also referred to that process also as: the mapping of the first page of the memory access pattern of the application in the GVA space to the GPA space may be re-layouted to map to first memory page in the GVA space of the first memory access pattern of the application to the memory page position in the GPA space, which is assigned by the memory mapping between the GPA space and the HVA space to the first memory page of this identified sequence in the HVA space). The former content of that memory page (for example an address in the HVA space) may be stored in a buffer or the like for later use, or it may be swapped with the content of the memory page whose content was moved to its position (the changing of the corresponding data in physical memory, e.g., HPA space, is described below). This may be implemented by the page table/list which contains the mappings. This table that may be updated. This process may be repeated for each memory page in the identified contiguous memory pages within the HVA space. Then the order of the GPA space was re-layout and thereby the second memory access pattern in the HVA space, corresponding to the first memory access pattern of the application, is now a sequential memory access pattern. A sequential memory access pattern refers to a way in which data or instructions are accessed in memory in a linear or consecutive order.

That re-layout of the GPA space may be referred to as to sequentialize the second memory pattern in the HVA space.

Therefore, for sequential applications a sequential page access pattern in the host (PM) context may be re-enabled and benefit from prefetching may be restored. Further, non-sequential (and stride) page access pattern may be converted into sequential page access patterns in the host (PM) context for non-sequential (and stride) applications with deterministic page access pattern, thus new opportunities for sequential prefetching may be introduced. As a result, the host may employ sequential pre-fetching of pages (for example from a compressed pool for sequential, non-sequential and stride applications running inside a virtualized environment).

For example, having a compression pool inside guest may have several disadvantages. It may make Kernel Same-page Merging (KSM) in the host ineffective as same pages across

VMs could be compressed and scattered inside individual VM's compressed pools. This may reduce the page merging opportunity in the host. As a result, the total memory usage at the host may increase. Further, this may depend upon VM use case. For example, in serverless or microservices users may not want to manage the underlying VM infrastructure, and configuring and tuning compressed pool inside a VM may not be preferred. It may be preferred to have host-based compressed pool managed by cloud service providers.

### Example of an Application with a Sequential Memory Access Pattern

For example, if an application in the GVA space has a sequential memory access pattern, like M_{GVA}, (M+1)_{GVA}, (M+2)_{GVA}, (M+3)_{GVA}. The GPA space may be ordered as follows: (N−2)_{GPA}, (N−1)_{GPA}, N_{GPA}, (N+1)_{GPA}(N+2)_{GPA}(N+3)_{GPA}(N+4)_{GPA}, (N+5)_{GPA}.

A mapping corresponding to the application, from the GVA space to the GPA space, may map the following memory pages to each other (this may be an example of a part of a page table):

M_{GVA}→(N−1)_{GPA}, (M+1)_{GVA}→(N+1)_{GPA}, (M+2)_{GVA}→(N+5)_{GPA}, (M+3)_{GVA}→(N+3)_{GPA}.

(M+3)_{GVA}→(N+3)_{GPA}

The mapping from the GPA space to the HVA space (also with regards to the memory access pattern of the application) may be as follows:

(N−2)_{GPA}→(O+1)_{HVA}, (N−1)_{GPA}→(O−2)_{HVA}, (N)_{GPA}→(O+3)_{HVA}

(N+1)_{GPA}→(O)_{HVA}, (N+2)_{GPA}→(O+4)_{HVA}(N+3)_{GPA}→(O+5)_{HVA}

(N+4)_{GPA}→(O−1)_{HVA}, (N−5)_{GPA}→(O+2)_{HVA}

The sequential memory access pattern in the GVA space may then for example yield the following non-sequential corresponding memory access pattern in the HVA space:

M_{GVA}→(0−2)_{HVA}, (M+1)_{GVA}→(O)_{HVA}, (M+2)_{GVA}→(O+2)_{HVA}, (M+3)_{GVA}→(O+5)_{HVA}.

(M+3)_{GVA}→(O+5)_{HVA}

For example, the apparatus 100 (for example the processing circuitry 104a/104c) may identify a sequence of four contiguous memory pages within the HVA space, because the length of the sequential memory access pattern of the application in the GVA space is 4, which may have the memory addresses: (O+2)_{HVA}, (O+3)_{HVA}, (O+4)_{HVA}, (O+5)_{HVA}. Then, the apparatus 100 (for example the processing circuitry 104a/104c) may begin with the first memory page of this identified sequence in the HVA space, (O+2)_{HVA}, and identify the corresponding memory page position in the GPA space which is assigned to it by the memory mapping between the GPA space and the HVA space, that may be according to the example the memory page position in GPA space (N+5)_{GPA}. Then the apparatus 100 (for example the processing circuitry 104a/104c) may identify the first memory page in the GVA space of the sequential memory access pattern of the application and the corresponding memory page in the GPA space to which it points, that is the mapping: M_{GVA}→(N−1)_{GPA}. Then apparatus 100 (for example the processing circuitry 104a/104c) may move the content of this identified memory page (for example an HVA) (N−1)_{GPA} from its position in the GPA space, (N−1)_{GPA}, to the identified memory page position in GPA space (N+5)_{GPA}. The former content of the memory page at the memory page position (N+5)_{GPA} may be stored in a buffer or the like for later use, or it may be swapped with the content at the memory position (N−1)_{GPA} (respectively the mapping of the first page of the memory access pattern of the application in the GVA space may be modified/re-layouted to map the memory page (M)_{GVA} to the memory page (N+5)_{GPA}). When making a re-layout of the GPA space, the corresponding mapping from the GVA space to that GPA space memory page also moves accordingly, for example the GVA space memory page (M)_{GVA} still maps to the content of the former memory page (N−1)_{GPA}, however this memory page is no longer at the memory page position (N−1)_{GPA} but at the memory page position (N+5)_{GPA}. (When the process of re-layout is finished, the naming of the GPA space may be adapted to be sequential integers again.) This process may be repeated for each memory page in the identified contiguous memory pages within the HVA space, (O+3)_{HVA}, (O+4)_{HVA}, (O+5)_{HVA}. Based on (O+3)_{HVA}, the GPA space may be re-layout so that the content of the memory page (N+1)_{GPA} is moved to the memory page position (N)_{GPA} (the content of the former memory page (N)_{GPA} may be stored in a buffer or swapped). Based on (O+4)_{HVA}, the GPA space may be re-layout so that the content of the memory page (N+5)_{GPA} is moved to the memory page position (N)_{GPA}. It may always be referred to the content of a memory page position like it was before the process of re-layout for a specific application started. That may be in this case the content of former memory page (N+5)_{GPA} which was stored in a buffer, not to the content of former memory page (N−1)_{GPA} which is stored in memory page position (N+5)_{GPA} now. Based on (O+5)_{HVA}, the GPA space may be re-layout so that the content of the memory page (N+5)_{GPA} is moved to the memory page position (N)_{GPA} (the content of the former memory page (N)_{GPA} may be stored in a buffer or swapped). Based on (O+5)_{HVA}, GPA space may be re-layout so that (N+3)_{GPA} is moved to the memory page position (N+3)_{GPA}, that means in this example it is not moved. Then the new layout of the GPA space may be:

(N−2)_{GPA}, (N+2)_{GPA}, N_{GPA}, (N+1)_{GPA}, (N+5)_{GPA}, (N+3)_{GPA}, (N+4)_{GPA}, (N−1)_{GPA}.

Then, the new memory access pattern in the HVA space, corresponding to the memory access pattern of the application in the GVA, may a sequential memory access pattern in the HVA space:

M_{GVA}→(0+2)_{HVA}, (M+1)_{GVA}→(O+3)_{HVA}, (M+2)_{GVA}→(O+4)_{HVA}, (M+3)_{GVA}→(O+5)_{HVA}.

(M+3)_{GVA}→(O+5)_{HVA}

Therefore, by performing a re-layout of GPA space (modify the layout of the GPA space) the sequential memory access pattern of the application in the GVA space is sequentialized in the HVA space of the host. The moving of the corresponding memory pages in the actual physical memory, HPA space, is described below.

### Example of an Application with a Stride Memory Access Pattern

addr, addr+n, addr+2n, addr+3n (M)_{GVA}, (M+2)_{GVA}, (M+4)_{GVA}, (M+6)_{GVA} Also, for example by performing a re-layout of the GPA space, a memory pattern in the HVA space is sequentialized in case of stride memory access pattern of the application in the GVA space. A stride memory access pattern may for example be an access pattern such as

addr, addr+n, addr+2n, addr+3n (M)_{GVA}, (M+2)_{GVA}, (M+4)_{GVA}, (M+6)_{GVA} or the like (addr may be an abbreviation for address and refers to an address space, n may be an integer). An application in the GVA space may have a stride memory access pattern, like. The GPA space may be ordered as in the sequential example above. A mapping corresponding to the application, from the GVA space to the GPA space, may map the following memory pages to each other (that may for example be a part of the page table):

(M)_{GVA}→(N−1)_{GPA}, (M+2)_{GVA}→(N+1)_{GPA}, (M+4)_{GVA}→(N+5)_{GPA}, (M+6)_{GVA}→(N+3)_{GPA}.

(M+6)_{GVA}→(N+3)_{GPA}

The stride memory access pattern in the GVA space may then for example yield the following non-sequential corresponding memory access pattern in the HVA space:

(M)_{GVA}→(0)_{HVA}, (M+2)_{GVA}→(O)_{HVA}, (M+4)_{GVA}→(O+2)_{HVA}, (M+6)_{GVA}→(O+5)_{HVA}.

(M+6)_{GVA}→(O+5)_{HVA}

For example, the apparatus 100 (for example the processing circuitry 104a/104c) may identify a sequence of four contiguous memory pages within the HVA space, because the length of the stride memory access pattern of the application in the GVA space is 4, which may have the memory address: (O+2)_{HVA}, (O+3)_{HVA}, (O+4)_{HVA}, (O+5)_{HVA}. Then, the apparatus 100 (for example the processing circuitry 104a/104c) may begin with the first memory page of this identified sequence in the HVA space, (O+2)_{HVA}, and identify the corresponding memory page position in the GPA space which is assigned to it by the memory mapping between the GPA space and the HVA space, that may be according to the example the memory page position in GPA space (N+5)_{GPA}. Then the apparatus 100 (for example the processing circuitry 104a/104c) may identify the first memory page in the GVA space of the stride memory access pattern of the application and the corresponding memory page in the GPA space to which it points, that is the mapping: (M+3)_{GVA}→(N−1)_{GPA}. Then the apparatus 100 (for example the processing circuitry 104a/104c) may move the content of this identified memory page (N−1)_{GPA} from its position in the GPA space, (N−1)_{GPA}, to the identified memory page position in GPA space (N +5)_{GPA}. The former content of the memory page in the physical memory at the memory page position (N+5)_{GPA} may be stored in a buffer or the like for later use, or it may be swapped with the content at the memory position (N−1)_{GPA} (respectively the mapping of the first page of the memory access pattern of the application in the GVA space may be re-layouted to map the memory page (M+3)_{GVA} to the memory page (N+5)_{GPA}). When moving the content of a memory page within the GPA space, the corresponding mapping from the GVA space to that GPA space memory page also moves accordingly, for example the GVA space memory page (M+3)_{GVA} still maps to the content of the former memory page (N−1)_{GPA}, however this memory page is no longer at the memory page position (N−1)_{GPA} but at the memory page position (N+5)_{GPA}. (When the process of re-layout is finished, the naming of the GPA space may be adapted to be sequential integers again.) This may also be implemented by updating the page table accordingly. This process may be repeated for each memory page in the identified contiguous memory pages within the HVA space, (O+3)_{HVA}, (O+4)_{HVA}, (O+5)_{HVA}. Based on (O+3)_{HVA}, the GPA space may be re-layout so that the content of the memory page (N+1)_{GPA} (corresponding to the second memory page (M+2)_{GVA} of the stride pattern in the GVA space) is moved to the memory page position (N)_{GPA} (the content of the former memory page (N)_{GPA} may be stored in a buffer or swapped). Based on (O+4)_{HVA}, the GPA space may be re-layout so that the content of the memory page (N+5)_{GPA} (corresponding to the third memory page (M+4)_{GVA} of the stride memory access pattern in the GVA space) is moved to the memory page position (N)_{GPA}. It may always be referred to the content of a memory page position like it was before the process of re-layout for a specific application started. That may be in this case the content of former memory page position (N+5)_{GPA} which was stored in a buffer, not to the content of former memory page (N−1)_{GPA} which is stored in memory page position (N+5)_{GPA} now. Based on (O+5)_{HVA}, the GPA space may be re-layout so that the content of the memory page (N+5)_{GPA} (corresponding to the fourth memory page (M+4)_{GVA} of the stride memory access pattern in the GVA space)is moved to the memory page position (N)_{GPA} (the content of the former memory page (N)_{GPA} may be stored in a buffer or swapped). Based on (O+5)_{HVA}, GPA space may be re-layout so that (N+3)_{GPA} is moved to the memory page position (N+3)_{GPA}, that means in this example it is not moved. Then the new layout of the GPA space may then be:

(N−2)_{GPA}, (N+2)_{GPA}, N_{GPA}, (N+1)_{GPA}, (N+5)_{GPA}, (N+3)_{GPA}, (N+4)_{GPA}, (N−1)_{GPA}.

Then, the new memory access pattern in the HVA space, corresponding to the stride memory access pattern of the application in the GVA, may be a sequential memory access pattern in the HVA space:

(M)_{GVA}→(0+2)_{HVA}, (M+2)_{GVA}→(O+3)_{HVA}, (M+4)_{GVA}→(O+4)_{HVA}, (M+6)_{GVA}→(O+5)_{HVA}.

(M+6)_{GVA}→(O+5)_{HVA}

Therefore, by performing a re-layout of GPA space the stride memory access pattern of the application in the GVA space is sequentialized in the HVA space of the host. The moving of the corresponding memory pages in the actual physical memory, HPA space, is described below.

### Example of an Application with a Non-Sequential but Deterministic Memory Access Pattern

(M+3)_{GVA}, (M)_{GVA}, (M+1)_{GVA}, (M+2)_{GVA} Also, for example by performing a re-layout of the GPA space, a memory pattern in the HVA space is sequentialized in case of a non-sequential but deterministic memory access pattern of the application in the GVA space. A non-sequential memory access pattern may, when it is executed along a time-dimension, access memory pages one after the other, which are not ordered in a spatial sequence in the memory space. An application in the GVA space may have a non-sequential but deterministic memory access pattern, like (M+3)_{GVA}, (M)_{GVA}, (M+1)_{GVA}, (M+2)_{GVA}. The GPA space may be ordered as in the sequential example above. A mapping corresponding to the application, from the GVA space to the GPA space, may map the following memory pages to each other (that may be an example of a part of a page table):

(M+3)_{GVA}→(N−1)_{GPA}, (M)_{GVA}→(N+1)_{GPA}, (M+1)_{GVA}→(N+5)_{GPA}, (M+2)_{GVA}→(N+3)_{GPA}.

(M+2)_{GVA}→(N+3)_{GPA}

The non-sequential but deterministic memory access pattern in the GVA space may then for example yield the following non-sequential corresponding memory access pattern in the HVA space:

(M+3)_{GVA}→(0−2)_{HVA}, (M)_{GVA}→(O)_{HVA}, (M+1)_{GVA}→(O+2)_{HVA}, (M+2)_{GVA}→(O+5)_{HVA}.

(M+2)_{GVA}→(O+5)_{HVA}

For example, the apparatus 100 (for example the processing circuitry 104a/104c) may identify a sequence of four contiguous memory pages within the HVA space, because the length of the non-sequential memory access pattern of the application in the GVA space is 4, which may have the memory address: (O+2)_{HVA}, (O+3)_{HVA}, (O+4)_{HVA}, (O+5)_{HVA}. Then, the apparatus 100 may begin with the first memory page of this identified sequence in the HVA space, (O+2)_{HVA}, and identify the corresponding memory page position in the GPA space which is assigned to it by the memory mapping between the GPA space and the HVA space, that may be according to the example the memory page position in GPA space (N+5)_{GPA}. Then the apparatus 100 (for example the processing circuitry 104a/104c) may identify the first memory page in the GVA space of the non-sequential memory access pattern of the application and the corresponding memory page in the GPA space to which it points, that is the mapping: (M+3)_{GVA}→(N−1)_{GPA}. Then the apparatus 100 may move the content of this identified memory page (N−1)_{GPA} from its position in the GPA space, (N−1)_{GPA}, to the identified memory page position in GPA space (N+5)_{GPA}. The former content of the memory page at the memory page position (N+5)_{GPA} may be stored in a buffer or the like for later use, or it may be swapped with the content at the memory position (N−1)_{GPA} (respectively the mapping of the first page of the memory access pattern of the application in the GVA space may be re-layouted to map the memory page (M+3)_{GVA} to the memory page (N+5)_{GPA}). When moving the content of a memory page within the GPA space, the corresponding mapping from the GVA space to that GPA space memory page also moves accordingly, for example the GVA space memory page (M+3)_{GVA} still maps to the content of the former memory page (N−1)_{GPA}, however this memory page is no longer at the memory page position (N−1)_{GPA} but at the memory page position (N+5)_{GPA}. (When the process of re-layout is finished, the naming of the GPA space may be adapted to be sequential integers again.) This may be implemented by updating the corresponding entries in the page table. This process may be repeated for each memory page in the identified contiguous memory pages within the HVA space, (O+3)_{HVA}, (O+4)_{HVA}, (O+5)_{HVA}. Based on (O+3)_{HVA}, the GPA space may be re-layout so that the content of the memory page (N+1)_{GPA} (corresponding to the second memory page (M)_{GVA} of the non-sequential pattern in the GVA space) is moved to the memory page position (N)_{GPA} (the content of the former memory page (N)_{GPA} may be stored in a buffer or swapped). Based on (O+4)_{HVA}, the GPA space may be re-layout so that the content of the memory page (N+5)_{GPA} (corresponding to the third memory page (M+1)_{GVA} of the non-sequential pattern in the GVA space) is moved to the memory page position (N)_{GPA}. It may always be referred to the content of a memory page position like it was before the process of re-layout for a specific application started. That may be in this case the content of former memory page position (N+5)_{GPA} which was stored in a buffer, not to the content of former memory page (N−1)_{GPA} which is stored in memory page position (N+5)_{GPA} now. Based on (O+5)_{HVA}, the GPA space may be re-layout so that the content of the memory page (N+5)_{GPA} (corresponding to the fourth memory page (M+2)_{GVA} of the non-sequential pattern in the GVA space)is moved to the memory page position (N)_{GPA} (the content of the former memory page (N)_{GPA} may be stored in a buffer or swapped). Based on (O+5)_{HVA}, GPA space may be re-layout so that (N+3)_{GPA} is moved to the memory page position (N+3)_{GPA}, that means in this example it is not moved. Then the new layout of the GPA space may then be:

(N−2)_{GPA}, (N+2)_{GPA}, N_{GPA}, (N+1)_{GPA}, (N+5)_{GPA}, (N+3)_{GPA}, (N+4)_{GPA}, (N−1)_{GPA}.

Then, the new memory access pattern in the HVA space, corresponding to the non-sequential but deterministic memory access pattern of the application in the GVA, may be a sequential memory access pattern in the HVA space:

(M+3)_{GVA}→(0+2)_{HVA}, (M)_{GVA}→(O+3)_{HVA}, (M+1)_{GVA}→(O+4)_{HVA}, (M+2)_{GVA}→(O+5)_{HVA}.

(M+2)_{GVA}→(O+5)_{HVA}

Therefore, by performing a re-layout of the GPA space the non-sequential but deterministic memory access pattern of the application in the GVA space is sequentialized in the HVA space of the host. The moving of the corresponding memory pages in the actual physical memory, HPA space, is described below.

### Further Examples

Sequential prefetching may be possible, due to the modifying of the layout of the GPA space (re-layout of the GPA space) as described above, in host-managed systems for sequential, stride or non-sequential memory access patterns of an application in a VM. Therefore, wait times associated with fetching data may be reduced and, thus performance may be improved. Further, latency may be improved, e.g., prefetching may significantly decrease the time a processor spends waiting for data to be fetched. Further, the throughput may be improved, e.g., with reduced wait times, the system may process more tasks or data in a given period, resulting in higher throughput. Further, network latency may be improved, e.g., for distributed systems or cloud applications, prefetching may help mitigate the latency associated with retrieving data over a network. Furthermore, in cloud computing environments parallel decompression units may be leveraged in the host to concurrently decompress pages during sequential prefetching for sequential, stride and non-sequential applications running inside a virtualized environment. As a result, this the utility of virtualization engines in virtualized environments may be improved.

Further the total costs of memory for cloud service providers may be reduced and well-kwon sequential prefetching policies may be used in the host even in virtualized environment without requiring any other complex prefetching mechanism.

Further, the host benefits from sequential prefetching of guest pages (for example from a compressed pool). This allows reduced Memory total cost of ownership in virtualized environments at similar application performance levels.

More details and aspects of modifying a layout of the GPA space of a sequential memory access pattern are shown in FIG. 2. FIG. 2 schematically shows in the left side of the figure a lost sequentiality at HVA level due to two level of independent address translation. FIG. 2 schematically shows on the right side of the figure a maintaining of sequentiality at the HVA level, by using an GPA space re-layout. Because prefetching is performed in the HVAs, the actual HVA to HPA mapping may not be relevant for this purpose. The left and the right part of FIG. 2 schematically show the GVA space 202 comprising the GVA space memory pages (GVAs) 1, 2, 3, 4, 5, 6, 7, 8. It further shows the GPA space 204 comprising the GPA space memory pages (GPAs) 1, 2, 3, 4, 5, 6, 7, 8. It further shows the HVA space 206 comprising the HVA space memory pages (HVAs) 1, 2, 3, 4, 5, 6, 7, 8.

An application (without a virtual machine) may for example access the virtual address VA 1, VA 2, VA 3, and VA 4 in sequential order. If for example these pages are cold and placed in a compressed memory pool, then when the application page faults on VA 1, the prefetcher will prefetch (decompress) pages VA 2, VA 3 and VA 4 and place it in the memory (e.g., DRAM). Hence, by the time the application accesses VA 2, the page is already decompressed and available in DRAM. As a result, the application will not incur page fault on VA 2, VA 3, and VA 4.

The same application may for example be running inside a VM having the sequential memory access pattern 208, accessing GVAs GVA 1, GVA 2, GVA 3 and GVA 4 in sequential order, as shown on the left side of FIG. 2 The memory access pattern 208 translates in the corresponding GPA space memory access pattern 210 GPA 4, GPA 3, GPA 1, GPA 8. Further, the memory access pattern 210 translates in the corresponding HVA space memory access pattern 212 HVA 4, HVA 3, HVA 1, HVA 8, because there is a one-to-one mapping between the GPA space and the HVA space. This memory access pattern is not sequential anymore (for example the memory access pattern seen at the HVA level in the host may depend on how the OS memory management subsystem inside the guest allocates GPA to the applications). If the pages are cold and placed in a compressed memory pool managed in the host, then when the application page faults on GVA 1, the host sees the page fault at HVA 4. The sequential prefetcher in the host prefetches (in this case for example decompresses) pages HVA 5, HVA 6 and HVA 7 because prefetching may be done in the HVA space using host virtual address and is not aware of memory access pattern of applications running inside the guest. However, none of these pages correspond to GVA 2, GVA 3 and GVA 4. Therefore, the application may incur a page fault again when GVA 2 is accessed and the prefetched pages at HVA 5, HVA 6 and HVA 7 are useless and thus this is impacting prefetching accuracy.

Therefore, the GPA space 204 is re-layout into a re-layout GPA space 214 as shown on the right side of FIG. 2. The same application with the same memory access pattern 208 access the GVA space 202, that is application be sequentially accessing GVA 1, GVA 2, GVA 3 and GVA 4 is run. Then the guest address space re-layout identifies and allocates contiguous physical memory GPA 3, GPA 4, GPA 5, and GPA 6 for the mentioned GVAs. If GPA3 to GPA6 are already allocated to a different application, they are moved to a different physical address. The GPA space 214 is then re-layout by ordering the memory pages (and their respective content) from the former order GPA 1, GPA 2, GPA 3, GPA 4, GPA 5, GPA 6, GPA 7, GPA 8 to the new order, for example as described above: GVA 5, GVA 2, GVA 4, GVA 3, GVA 1, GVA 8, GVA 7, GVA 7, GVA 6. Then the memory access pattern 216 in the GPA space 214 and the memory access pattern 218 in the HVA space 206 are also re-layout. After re-layout the memory pages may be re-named so that their naming is sequential again.

Now, if the memory pages are cold and placed in a compressed memory pool managed in the host, then when the application page faults on GVA 1, the host sees the page fault at HVA 3. The sequential prefetcher in the host prefetches (e.g., decompresses) pages HVA 4, HVA 5 and HVA 6 because it uses host virtual address for prefetching. Hence corresponding applications pages GVA 2, GVA3 and GVA 4 are decompressed and available in memory (e.g., DRAM) by the time application accesses them.

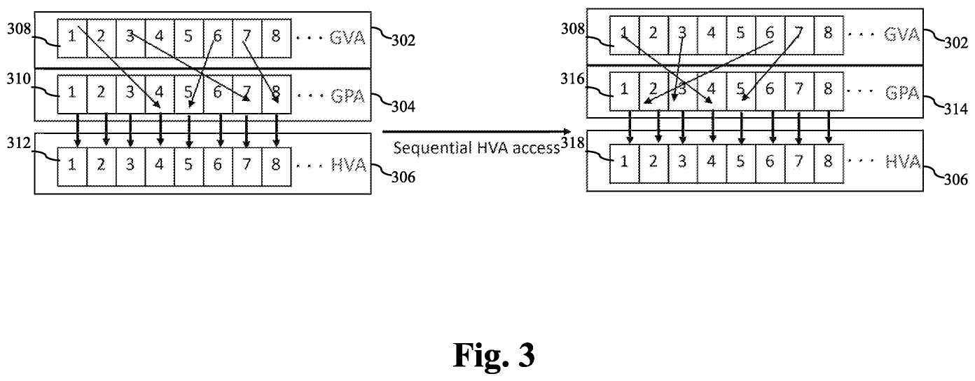

More details and aspects of modifying a layout of the GPA space of a non-sequential memory access pattern are shown in FIG. 3. FIG. 3 schematically shows how by virtualization sequentiality in HVA space of an application of a non-sequential but deterministic memory access pattern can be enforced. The left and the right part of FIG. 3 schematically show the GVA space 302 comprising the GVA space memory pages (GVAs) 1, 2, 3, 4, 5, 6, 7, 8. It further shows the GPA space 304 comprising the GPA space memory pages (GPAs) 1, 2, 3, 4, 5, 6, 7, 8. It further shows the HVA space 306 comprising the HVA space memory pages (HVAs) 1, 2, 3, 4, 5, 6, 7, 8.

For example, the application has memory access pattern 308 of a workload (e.g., an application) GVA 6, GVA 3, GVA 1, and GVA 7. Such non-sequential deterministic page access pattern may be seen in applications during data structure traversal (e.g., an application repeatedly traversing an unmodified linked list results in non-sequential deterministic page access pattern during each traversal). The memory access pattern 308 translates in the corresponding GPA space memory access pattern 310 GPA 5, GPA 7, GPA 4, GPA 8. Further, the memory access pattern 310 translates in the corresponding HVA space memory access pattern 312 HVA 5, HVA 7, HVA 4, HVA 8, because the GPA space to HVA space mapping is a one-to-one mapping (a linear mapping).

Then on the right side of FIG. 3 the GVA space to GPA space mapping is remapped by using a GPA re-layout which yields a re-layout GPA space 314 with a memory access pattern 316. Thereby, a sequential memory access pattern 318 at HVA space is enforced and a sequential prefetching at host after the re-layout is utilized. The right part of FIG. 3 schematically shows the GVA to GPA mapping after re-layout (by performing the re-layout of the GPA space the memory access patterns 316 in the GPA space is also re-layout). Because the GPA space to HVA space mapping is a one-to-one mapping (a linear mapping) the HVA space is also automatically re-layout. After re-layout the memory pages may be re-named so that their naming is sequential again. Then, if all these pages are now cold and placed in a compressed memory pool managed in the host then when the application page faults on GVA 6, the host sees the page fault at HVA 2. The sequential prefetcher in the host prefetches (e.g., decompresses) pages HVA 3, HVA 4 and HVA 5 because it may use host virtual address for prefetching. Hence corresponding applications pages GVA 3, GVA 1, and GVA 7 in the GVA space are decompressed and available in the memory (e.g., DRAM) by the time application accesses them.

Enforcing sequential memory access pattern for applications with non-sequential deterministic page access pattern may be possible in a virtualized environment. Therefore, GPA space re-layout may be useful even for non-sequential applications with deterministic page access pattern.

The apparatus 100 (for example the processing circuitry 104a/104c) performs a one-to-one mapping between a guest physical address in the guest physical address space and a host virtual address in the host virtual address space. A one-to-one mapping between the GPA space and the HVA space may be a mapping where a sequence of memory pages in the GPA space is mapped onto a sequence of memory pages in the HVA space. In other examples, there may also be another mapping between the GPA space and the HVA space where a re-layout of a guest physical address space, which is corresponding to the guest virtual address space, is performed to sequentialize a second memory access pattern in a host virtual address space, which is corresponding to the first memory access pattern of the application in the guest virtual address space.

The apparatus 100 (for example the processing circuitry 104a/104c) identifies a mapping corresponding to the application, which is mapping a guest virtual address of the first memory access pattern in the guest virtual address space to a guest physical address of the third memory access pattern in the guest physical address space.

### Migration of a Memory Page

The apparatus 100 identifies a set of available sequential memory pages in the guest physical address space for sequentially storing memory pages corresponding to the third memory access pattern in the guest physical address space. With regards to memory allocation, particularly with reference to dynamic memory allocation in computer systems, there may be various approaches or algorithms that may be used to allocate chunks of memory from a block of free memory.

The apparatus 100 (for example the processing circuitry 104a/104c) may perform a best fit approach or a first fit approach or any other approach to identify a set of available sequential memory pages corresponding to the third memory access pattern in the guest physical address space.

The best fit algorithm may search an entire list of free memory pages (blocks) and allocates from the smallest block of memory that is sufficient to hold the object. The idea is to minimize the amount of memory wasted in the remaining free block after allocation.

The first fit algorithm may start at the beginning of a list and allocates memory from the first block that is large enough to accommodate the object. It doesn't necessarily give the best match, but it may be faster than the best fit because it doesn't always traverse the entire list.

Further approaches may include a next fit approach, which may be like a first fit approach, but it keeps track of where it left off in the memory list. When another allocation is needed, it starts searching from the last allocated point rather than the beginning of the list. This may be more efficient than first fit approach, depending on the distribution and patterns of allocations and deallocations. Further approaches may include a worst fit approach, which may search for the largest available block of memory and allocates it. The idea behind this may be that the large block can accommodate future allocations as well. However, in practice, this method can lead to significant memory fragmentation over time.

The apparatus 100 (for example the processing circuitry 104a/104c) migrates the memory pages corresponding to the third memory access pattern in the guest physical address space to the identified set of sequential guest physical memory pages.

The apparatus 100 (for example the processing circuitry 104a/104c) performs the migration of the memory pages in the guest physical address space by updating a memory page table to reflect the modifying of the layout of the guest physical address space.

The migration of the memory pages in the GPA space, e.g., the re-layout of the GPA space, may be achieved by updating a page table. The page table may be a Translation Lookaside Buffer (TLB) or the like. The table may store which GVA is mapped to which GPA. The re-layout of the GPA may be achieved by updating the entries of the page table such that the new GVAs correspond to the new GPAs.

The apparatus 100 (for example the processing circuitry 104a/104c) performs a corresponding migration (moving) of the memory pages in the host physical space by copying the content of the corresponding memory pages in HPA space. The re-layout of the GPA and the update of the page table may also be implemented in the physical memory, for example the HPA space. The host physical address space may be the real, tangible address space in the host's physical memory (e.g., RAM). Only at the HPA there may be the actual data physically stored. For example, the content of a corresponding memory page in the HPA space which should be moved is copied to a corresponding new memory page in the HPA space, and the content of that HPA page may be stored in a buffer or the like for later use (or it may be swapped with the content of the memory page whose content was moved to its position) and then the content that should be moved is copied to the identified memory page in the HPA space.

The apparatus 100 (for example the processing circuitry 104a/104c) performs a corresponding migration of the memory pages in the host physical space by a zero-copy operation. A zero-copy-operation may refer to a method of data transfer between memory areas, for example between two memory pages inside the HPA space, or system buffers where a processing circuitry is not used to copy data from one area or buffer to another. The zero-copy operation may refer to modifying (re-layout) a mapping from the HVA space to the HPA space in such a way that, after re-layout of the GPA space, the memory access pattern in the GVA space still corresponds to the same HPA space memory access pattern without actually copying (moving) data of the memory pages. Thereby, the overhead of copying data multiple times may be avoided. For example, the mapping between the HVA space and the HPA space may be re-layout in such a way that without actually copying any memory pages inside the HPA space application with a specific memory pattern in the GVA space access the same memory pages in the HPA space before and after re-layout of the GPA space as described above. This applies for sequential, stride or non-sequential but deterministic memory access patterns.

Then a zero-copy-operation (migration) may be performed by adequately modifying HVA to HPA mapping inside the host, after modifying the GVA to GPA mapping, by performing a re-layout, inside the guest to access GPAs sequentially. Adequately modifying may be, that a value in HPA space remains the same when a corresponding GVA is accessed after changing the mappings from GVA to GPA and/or (in case that GVA to GPA mapping is not a one-to-one mapping, for example for QEMU/KVM) from GPA to HVA. Therefore, information from the guest may be obtained such as the mapping before re-layout of the GPA space (old GVA to GPA mapping) and the corresponding mapping after the re-layout of the GPA space (new modified GVA to GPA mapping) to correctly perform the required modification in the HVA to HPA mapping inside the host. The GVA space memory access pattern of the application may not be modifiable.

The apparatus 100 (for example the processing circuitry 104a/104c) performs the migration of the memory pages in the host physical address space by adjusting a corresponding mapping from a host virtual address of the second memory access pattern inside the host virtual address space to a host physical address of a fourth memory access pattern in the host physical address space, which is corresponding to the first memory access pattern of the application in the guest virtual address. For example, the mapping between the HVA space and the HPA space may be adjusted in such a way that without actually copying any memory pages inside the HPA space application with a specific memory pattern in the GVA space access the same memory pages in the HPA space before and after re-layout of the GPA space as described above.

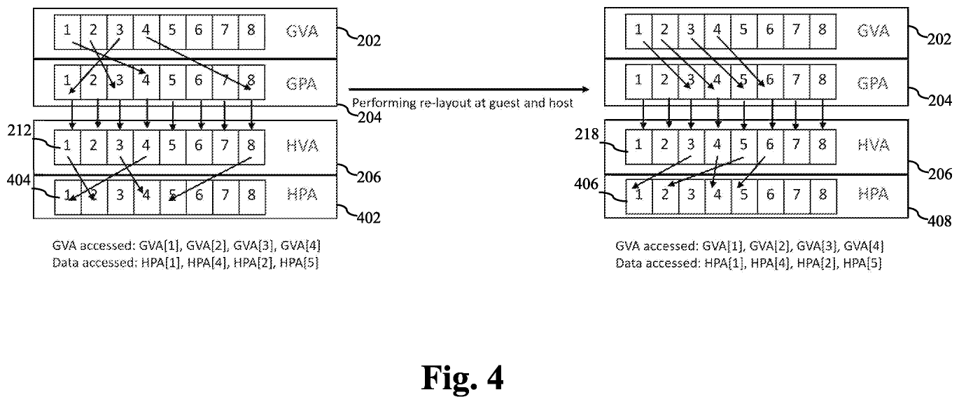

FIG. 4 schematically shows an adjusting of a mapping between the HVA space and the HPA space when modifying a layout at the GPA space. FIG. 4 is a continuation of the example given in FIG. 2, wherein FIG. 4 also comprises the HPA space 402/408. The left and the right part of FIG. 4 schematically show the GVA space 202 comprising the GVA space memory pages (GVAs) 1, 2, 3, 4, 5, 6, 7, 8. It further shows the GPA space 204 comprising the GPA space memory pages (GPAs) 1, 2, 3, 4, 5, 6, 7, 8. It further shows the HVA space 206 comprising the HVA space memory pages (HVAs) 1, 2, 3, 4, 5, 6, 7, 8. It further shows the HPA space 402 comprising the HVA space memory pages (HPAs) 1, 2, 3, 4, 5, 6, 7, 8. Furthermore, FIG. 4 shows the second memory access pattern 212 in the HVA space 206 and mapping from the HVA space to the HPA space with a corresponding fourth memory access pattern 404 in HPA space 402, which is 1, 4, 2, 5. An application with a memory access pattern in the GVA space like GVA[1], GVA[2], GVA[3], GVA[4] therefore leads to a memory access pattern 404 in the HPA space of HPA[1], HPA[4], HPA[2], HPA[5].

As described with FIG. 2 above a re-layout of the GPA space 204 is performed which yields a re-layout GPA space 214 and a sequentialized HVA space memory access pattern 218. The memory pages in the GPA space are re-ordered or moved (migrated) as described above, for example by moving the entries in the page table. However, in order to make sure, that the memory pages of the application in the GVA space still access the same memory pages, and therefore the same data, in the physical memory, the HPA space, with the actual data for the application stored in them, either the content of the memory pages in the HPA space may be copied to other memory pages which corresponds to the re-layout of the GPA space or the mapping from the HVA space to the HPA space may be re-layout. In this example, the mapping to the HPA[1] memory page is mapped from the HVA[3] memory page instead of the HVA[4] memory page. For example, the mapping to the HPA[4] memory page is mapped from the HVA[4] memory page instead of the HVA[3] memory page. For example, the mapping to the HPA[2] memory page is mapped from the HVA[5] memory page instead of the HVA[1] memory page. For example, the mapping to the HPA[5] memory page is mapped from the HVA[6] memory page instead of the HVA[8] memory page. Then, even after re-layout of the GPA space, shown on the right side of FIG. 4, the application with the memory access pattern 208 in the GVA space GVA[1], GVA[2], GVA[3], GVA[4], still has the same memory access pattern 408 in the HPA space of HPA[1], HPA[4], HPA[2], HPA[5] as before the re-layout of the GPA space. This is achieved without actually coping any data. This has the advantage of saving power and computational resources. This may be an implementation of a zero-copy operation. FIG. 4 correspondingly applies for sequential, stride or non-sequential but deterministic memory access patterns.

The apparatus 100 (for example the processing circuitry 104a/104c) performs sequential prefetching of memory pages by the host, corresponding to the application running inside the virtual machine, from a slower memory managed by the host into the host virtual address space. The slower memory may for example be the main memory, for example RAM.

The slower memory may also be a compressed memory pool. The apparatus 100 (for example the processing circuitry 104a/104c) may parallelly prefetches the memory pages identified for sequential prefetching.

Sequential prefetching of pages from a compressed memory pool may use a virtual address of the faulting page for prefetching. In case of a virtualized environment, when the compressed memory pool (e.g., ZSWAP) is configured and managed in host level, prefetching of pages may use HVA. One way to address the issue of ever-increasing memory inefficiencies in cloud environments may be to place memory pages (that is fixed-sized block of a memory space) of VMs that has not been accessed or used for a significant amount of time (that may be referred to as “cold memory page”) in a compressed memory pool (for example ZSWAP or Slab in Linux OS). This can enhance memory capacity and enable a CSP to deploy a greater number of VMs per gigabyte of physical memory. However, memory pages may be decompressed (incurring a penalty) whenever an application accesses them. Decompressing a VM's page on-demand (e.g., when an application faults on a memory page that was placed in compressed memory pool) may incur high overheads. To eliminate high decompression overheads from critical page fault path, sequential pre-fetching of pages from compressed memory pool may be employed. For example, prefetching may comprise loading and/ or decompressing a cold memory page that was compressed and stored in a compressed memory pool. In sequential prefetching, a set of n sequential pages from a faulting virtual address may (speculatively) be prefetched or decompressed from compressed memory pool, such that a predicted future accesses to these sequential pages will not incur additional page faults. Therefore, the above described technique may enable sequential prefetching from a compressed memory pool for virtualized environments using guest physical address space re-layout.

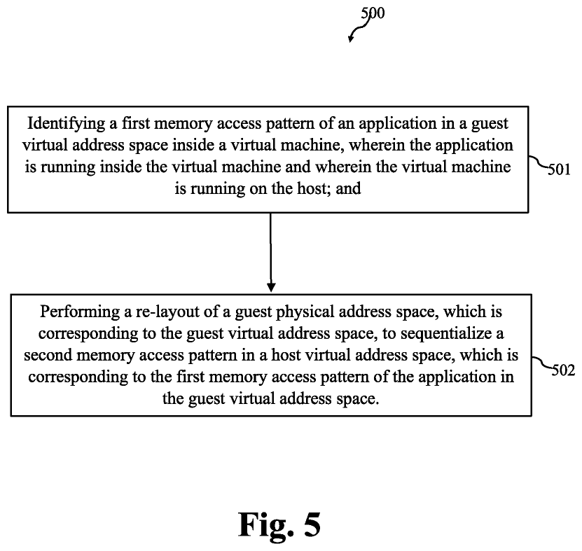

FIG. 5 illustrates a flowchart of an example of a method 500 for enabling sequential prefetching inside a host. The method 500 comprises identifying 501 a first memory access pattern of an application in a guest virtual address space inside a virtual machine, wherein the application is running inside the virtual machine and wherein the virtual machine is running on the host. The method 500 further comprises performing 502 a re-layout of a guest physical address space, which is corresponding to the guest virtual address space, to sequentialize a second memory access pattern in a host virtual address space, which is corresponding to the first memory access pattern of the application in the guest virtual address space.

In some examples the method 500 may further comprise performing the re-layout of a guest physical address by sequentializing a third memory access pattern in the guest physical address space, which is corresponding to the first memory access pattern of the application in the guest virtual address.

In some examples the method 500 may further comprise performing a one-to-one mapping between a guest physical address in the guest physical address space and a host virtual address in the host virtual address space.

In some examples the method 500 may further comprise identifying a mapping corresponding to the application, which is mapping a guest virtual address of the first memory access pattern in the guest virtual address space to a guest physical address of the third memory access pattern in the guest physical address space.

In some examples the method 500 may further comprise identifying a set of available sequential memory pages in the guest physical address space for sequentially storing memory pages corresponding to the third memory access pattern in the guest physical address space.

In some examples the method 500 may further comprise performing a best fit approach or a first fit approach to identify a set of available sequential memory pages corresponding to the third memory access pattern in the guest physical address space.

In some examples the method 500 may further comprise migrating the memory pages corresponding to the third memory access pattern in the guest physical address space to the identified set of sequential guest physical memory pages.

In some examples the method 500 may further comprise performing the migration of the memory pages in the guest physical address space by updating a memory page table to reflect the modifying of the layout of the guest physical address space.

In some examples the method 500 may further comprise performing a corresponding migration of the memory pages in the host physical space by a zero-copy operation.

In some examples the method 500 may further comprise performing the migration of the memory pages in the host physical space by adjusting a corresponding mapping from a host virtual address of the second memory access pattern inside the host virtual address space to a host physical address of a fourth memory access pattern in the host physical address space, which is corresponding to the first memory access pattern of the application in the guest virtual address.

In some examples the method 500 may further comprise performing sequential prefetching of memory pages by the host, corresponding to the application running inside the virtual machine, from a slower memory managed by the host into the host virtual address space. Further, the slower memory may be a compressed memory pool.

In some examples the method 500 may further comprise parallelly prefetching the memory pages identified for sequential prefetching. For example, the first memory access pattern of the application is a sequential access pattern, or a deterministic non-sequential access pattern or a stride access pattern.

Some examples relate to apparatus and method for enabling sequential prefetching inside a host. For example, a method comprising one or more of the following tasks may be carried out to implement a guest physical address space re-layout (a modifying of a layout of a GPA space): 1. May be identify the memory access pattern of either sequential or non-sequential application with deterministic page access pattern using profiling tools (e.g., Intel® PEBS). This task may give a set of access patterns. 2. For each access pattern in task 1, may be identify a set of contiguous guest physical pages either by using first fit or best fit approach. 3. If contiguous guest physical pages are not available, then may be migrate pages to different guest physical address to get contiguous guest physical pages. 4. For each access pattern in task 1, may be perform the guest physical address space re-layout by migrating the pages from old guest physical pages to new guest physical pages. Zero-data -copy page migration can be achieved, by suitably adjusting the memory mappings from HVA to HPA in the host with hints from the guest. 5. In task 4, follow the memory access pattern while may be assigning the new guest physical pages such that access will be sequential in the guest physical address space. 6. May be updating the page table entries to reflect new GVA to GPA mappings and free up the old GPAs. Invalidate TLBs for the updated pages inside the guest. 7. As GPA to HVA are 1-1 mapped, the sequential prefetching of pages from compressed memory pool at the HVA level in the host may prefetch the correct pages as per the application access pattern observed in the guest. 8. For example, use decompression engines (for example Intel's® IAA) to parallelly decompress the pages identified for sequential prefetching.

In the following, some examples of the proposed concept are presented:

An example (e.g., example 1) relates to an apparatus for enabling sequential prefetching inside a host, the apparatus comprising interface circuitry, machine-readable instructions, and processing circuitry to execute the machine-readable instructions to identify a first memory access pattern of an application in a guest virtual address space inside a virtual machine, wherein the application is running inside the virtual machine and wherein the virtual machine is running on the host, and modify a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.

Another example (e.g., example 2) relates to a previous example (e.g., example 1) or to any other example, further comprising that the processing circuitry is to execute the machine-readable instructions to modify the layout of the guest physical address space by sequentializing a third memory access pattern in the guest physical address space, wherein the third memory access pattern is corresponding to the first memory access pattern of the application in the guest virtual address.

Another example (e.g., example 3) relates to a previous example (e.g., one of the examples 1 or 2) or to any other example, further comprising that the processing circuitry is to execute the machine-readable instructions to perform a one-to-one mapping between a guest physical address in the guest physical address space and a host virtual address in the host virtual address space.

Another example (e.g., example 4) relates to a previous example (e.g., one of the examples 2 or 3) or to any other example, further comprising that the processing circuitry is to execute the machine-readable instructions to identify a mapping corresponding to the application, wherein the mapping is mapping a guest virtual address of the first memory access pattern in the guest virtual address space to a guest physical address of the third memory access pattern in the guest physical address space.

Another example (e.g., example 5) relates to a previous example (e.g., one of the examples 2 to 4) or to any other example, further comprising that the processing circuitry is to execute the machine-readable instructions to identify a set of available sequential memory pages in the guest physical address space for sequentially storing memory pages corresponding to the third memory access pattern in the guest physical address space.

Another example (e.g., example 6) relates to a previous example (e.g., example 5) or to any other example, further comprising that the processing circuitry is to execute the machine-readable instructions to perform a best fit approach or a first fit approach to identify a set of available sequential memory pages corresponding to the third memory access pattern in the guest physical address space.

Another example (e.g., example 7) relates to a previous example (e.g., one of the examples 5 or 6) or to any other example, further comprising that the processing circuitry is to execute the machine-readable instructions to migrate the memory pages corresponding to the third memory access pattern in the guest physical address space to the identified set of sequential guest physical memory pages.

Another example (e.g., example 8) relates to a previous example (e.g., example 7) or to any other example, further comprising that the processing circuitry is to execute the machine-readable instructions to perform the migration of the memory pages in the guest physical address space by updating a memory page table to reflect the modifying of the layout of the guest physical address space.

Another example (e.g., example 9) relates to a previous example (e.g., example 7) or to any other example, further comprising that the processing circuitry is to execute the machine-readable instructions to perform a corresponding migration of the memory pages in the host physical space by a zero-copy operation.

Another example (e.g., example 10) relates to a previous example (e.g., example 7) or to any other example, further comprising that the processing circuitry is to execute the machine-readable instructions to perform the migration of the memory pages in the host physical address space by adjusting a corresponding mapping from a host virtual address of the second memory access pattern inside the host virtual address space to a host physical address of a fourth memory access pattern in the host physical address space, wherein the fourth memory access pattern is corresponding to the first memory access pattern of the application in the guest virtual address.

Another example (e.g., example 11) relates to a previous example (e.g., one of the examples 1 to 10) or to any other example, further comprising that the processing circuitry is to execute the machine-readable instructions to perform sequential prefetching of memory pages by the host, corresponding to the application running inside the virtual machine, from a slower memory managed by the host into the host virtual address space.

Another example (e.g., example 12) relates to a previous example (e.g., example 11) or to any other example, further comprising that the slower memory is a compressed memory pool.

Another example (e.g., example 13) relates to a previous example (e.g., example 11) or to any other example, further comprising that the processing circuitry is to execute the machine-readable instructions to parallelly prefetching the memory pages identified for sequential prefetching.

Another example (e.g., example 14) relates to a previous example (e.g., one of the examples 1 to 13) or to any other example, further comprising that the first memory access pattern of the application is a sequential access pattern, or a deterministic non-sequential access pattern or a stride access pattern.

An example (e.g., example 15) relates to an apparatus for enabling sequential prefetching inside a host, comprising processing circuitry configured to identify a first memory access pattern of an application in a guest virtual address space inside a virtual machine, wherein the application is running inside the virtual machine and wherein the virtual machine is running on the host, and modify a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.

An example (e.g., example 16) relates to a device for enabling sequential prefetching inside a host comprising means for processing for identifying a first memory access pattern of an application in a guest virtual address space inside a virtual machine, wherein the application is running inside the virtual machine and wherein the virtual machine is running on the host, and modifying a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.

An example (e.g., example 17) relates to a method device for enabling sequential prefetching inside a host comprising identifying a first memory access pattern of an application in a guest virtual address space inside a virtual machine, wherein the application is running inside the virtual machine and wherein the virtual machine is running on the host, and modifying a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.

Another example (e.g., example 18) relates to a previous example (e.g., example 17) or to any other example, further comprising that the method comprises modifying the layout of a guest physical address by sequentializing a third memory access pattern in the guest physical address space, which is corresponding to the first memory access pattern of the application in the guest virtual address.

Another example (e.g., example 19) relates to a previous example (e.g., one of the examples 17 or 18) or to any other example, further comprising that the method comprises performing a one-to-one mapping between a guest physical address in the guest physical address space and a host virtual address in the host virtual address space.

Another example (e.g., example 20) relates to a previous example (e.g., one of the examples 18 or 19) or to any other example, further comprising that the method comprises identifying a mapping corresponding to the application, which is mapping a guest virtual address of the first memory access pattern in the guest virtual address space to a guest physical address of the third memory access pattern in the guest physical address space.

Another example (e.g., example 21) relates to a previous example (e.g., one of the examples 18 to 20) or to any other example, further comprising that the method comprises identifying a set of available sequential memory pages in the guest physical address space for sequentially storing memory pages corresponding to the third memory access pattern in the guest physical address space.

Another example (e.g., example 22) relates to a previous example (e.g., example 21) or to any other example, further comprising that the method comprises performing a best fit approach or a first fit approach to identify a set of available sequential memory pages corresponding to the third memory access pattern in the guest physical address space.

Another example (e.g., example 23) relates to a previous example (e.g., one of the examples 21 or 22) or to any other example, further comprising that the method comprises migrating the memory pages corresponding to the third memory access pattern in the guest physical address space to the identified set of sequential guest physical memory pages.

Another example (e.g., example 24) relates to a previous example (e.g., example 23) or to any other example, further comprising that the method comprises performing the migration of the memory pages in the guest physical address space by updating a memory page table to reflect the modifying of the layout of the guest physical address space.

Another example (e.g., example 25) relates to a previous example (e.g., example 23) or to any other example, further comprising that the method comprises performing a corresponding migration of the memory pages in the host physical space by a zero-copy operation.

Another example (e.g., example 26) relates to a previous example (e.g., example 23) or to any other example, further comprising that the method comprises performing the migration of the memory pages in the host physical address space by adjusting a corresponding mapping from a host virtual address of the second memory access pattern inside the host virtual address space to a host physical address of a fourth memory access pattern in the host physical address space, wherein the fourth memory access pattern is corresponding to the first memory access pattern of the application in the guest virtual address.

Another example (e.g., example 27) relates to a previous example (e.g., one of the examples 17 to 26) or to any other example, further comprising that the method comprises performing sequential prefetching of memory pages by the host, corresponding to the application running inside the virtual machine, from a slower memory managed by the host into the host virtual address space.

Another example (e.g., example 28) relates to a previous example (e.g., example 27) or to any other example, further comprising that the slower memory is a compressed memory pool.

Another example (e.g., example 29) relates to a previous example (e.g., example 28) or to any other example, further comprising that the method comprises to parallelly prefetching the memory pages identified for sequential prefetching.

Another example (e.g., example 30) relates to a previous example (e.g., one of the examples 17 to 29) or to any other example, further comprising that the first memory access pattern of the application is a sequential access pattern, or a deterministic non-sequential access pattern or a stride access pattern.

An example (e.g., example 31) relates to a non-transitory machine-readable storage medium including program code, when executed, to cause a machine to perform the method of identifying a first memory access pattern of an application in a guest virtual address space inside a virtual machine, wherein the application is running inside the virtual machine and wherein the virtual machine is running on the host, and modifying a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.

Another example (e.g., example 32) relates to a computer program having a program code for performing the method of any one of the examples 17 to 30 when the computer program is executed on a computer, a processor, or a programmable hardware component.

Another example (e.g., example 33) relates to machine-readable storage including machine readable instructions, when executed, to implement a method or realize an apparatus as claimed in any pending example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components.

Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means.

Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for enabling sequential prefetching inside a host, the apparatus comprising interface circuitry, machine-readable instructions, and processing circuitry to execute the machine-readable instructions to:
identify a first memory access pattern of an application in a guest virtual address space inside a virtual machine, wherein the application is running inside the virtual machine and wherein the virtual machine is running on the host; and
modify a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.

2. The apparatus according to claim 1, wherein the processing circuitry is to execute the machine-readable instructions to modify the layout of the guest physical address space by sequentializing a third memory access pattern in the guest physical address space, wherein the third memory access pattern is corresponding to the first memory access pattern of the application in the guest virtual address.

3. The apparatus according to claim 1, wherein the processing circuitry is to execute the machine-readable instructions to perform a one-to-one mapping between a guest physical address in the guest physical address space and a host virtual address in the host virtual address space.

4. The apparatus according to claim 2, wherein the processing circuitry is to execute the machine-readable instructions to identify a mapping corresponding to the application, wherein the mapping is mapping a guest virtual address of the first memory access pattern in the guest virtual address space to a guest physical address of the third memory access pattern in the guest physical address space.

5. The apparatus according to claim 2, wherein the processing circuitry is to execute the machine-readable instructions to identify a set of available sequential memory pages in the guest physical address space for sequentially storing memory pages corresponding to the third memory access pattern in the guest physical address space.

6. The apparatus according to claim 5, wherein the processing circuitry is to execute the machine-readable instructions to perform a best fit approach or a first fit approach to identify a set of available sequential memory pages corresponding to the third memory access pattern in the guest physical address space.

7. The apparatus according to claim 5, wherein the processing circuitry is to execute the machine-readable instructions to migrate the memory pages corresponding to the third memory access pattern in the guest physical address space to the identified set of sequential guest physical memory pages.

8. The apparatus according to claim 7, wherein the processing circuitry is to execute the machine-readable instructions to perform the migration of the memory pages in the guest physical address space by updating a memory page table to reflect the modifying of the layout of the guest physical address space.

9. The apparatus according to claim 7, wherein the processing circuitry is to execute the machine-readable instructions to perform a corresponding migration of the memory pages in the host physical space by a zero-copy operation.

10. The apparatus according to claim 7, wherein the processing circuitry is to execute the machine-readable instructions to perform the migration of the memory pages in the host physical address space by adjusting a corresponding mapping from a host virtual address of the second memory access pattern inside the host virtual address space to a host physical address of a fourth memory access pattern in the host physical address space, wherein the fourth memory access pattern is corresponding to the first memory access pattern of the application in the guest virtual address.

11. The apparatus according to claim 1, wherein the processing circuitry is to execute the machine-readable instructions to perform sequential prefetching of memory pages by the host, corresponding to the application running inside the virtual machine, from a slower memory managed by the host into the host virtual address space.

12. The apparatus according to claim 11, wherein the slower memory is a compressed memory pool.

13. The apparatus according to claim 11, wherein the processing circuitry is to execute the machine-readable instructions to parallelly prefetching the memory pages identified for sequential prefetching.

14. The apparatus according to claim 1, wherein the first memory access pattern of the application is a sequential access pattern, or a deterministic non-sequential access pattern or a stride access pattern.

15. A method device for enabling sequential prefetching inside a host comprising:
identifying a first memory access pattern of an application in a guest virtual address space inside a virtual machine, wherein the application is running inside the virtual machine and wherein the virtual machine is running on the host; and
modifying a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.

16. The method according to claim 15, wherein the method comprises modifying the layout of a guest physical address by sequentializing a third memory access pattern in the guest physical address space, which is corresponding to the first memory access pattern of the application in the guest virtual address.

17. The method of claim 15, wherein the method comprises performing a one-to-one mapping between a guest physical address in the guest physical address space and a host virtual address in the host virtual address space.

18. The method according to claim 16, wherein the method comprises identifying a mapping corresponding to the application, which is mapping a guest virtual address of the first memory access pattern in the guest virtual address space to a guest physical address of the third memory access pattern in the guest physical address space.

19. The method according to claim 16, wherein the method comprises identifying a set of available sequential memory pages in the guest physical address space for sequentially storing memory pages corresponding to the third memory access pattern in the guest physical address space.

20. A non-transitory machine-readable storage medium including program code, when executed, to cause a machine to perform the method of:
identifying a first memory access pattern of an application in a guest virtual address space inside a virtual machine, wherein the application is running inside the virtual machine and wherein the virtual machine is running on the host; and
modifying a layout of a guest physical address space to sequentialize a second memory access pattern in a host virtual address space, wherein the guest physical address space is corresponding to the guest virtual address space, and wherein the second memory access pattern in the host virtual address space is corresponding to the first memory access pattern of the application in the guest virtual address space.
